(19) United States
(12) Patent Application Publication
(10) Pub. No.: US 2014/0133052 A1
(43) Pub. Date: May 15, 2014

(54) MAGNETORESISTIVE SENSOR HAVING REDUCED READ GAP AND STRONG PINNED LAYER STABILITY

(71) Applicant: HGST NETHERLANDS B.V., Amsterdam (NL)

(72) Inventors: Kenichi Meguro, Ashigarakami-gun (JP); Keizo Kato, Tokyo (JP); Susumu Okamura, Odawara-shi (JP); Nobuo Yoshida, Hiratsuka-shi (JP)

(73) Assignee: HGST NETHERLANDS B.V., Amsterdam (NL)

(21) Appl. No.: 13/677,196

(22) Filed: Nov. 14, 2012

(51) Int. Cl. G11B 5/127; G11B 5/39

(52) U.S. Cl. CPC G11B 5/127; G11B 5/398
USPC 360/234.3; 428/811.2; 216/22

(57) ABSTRACT

A magnetic read head having a reduced read gap and a stable magnetic pinned layer structure. The sensor includes a seed layer that has a surface formed with an anisotropic texture. A magnetic pinned layer formed over the seed layer has a body centered cubic structure which causes the pinned layer structure to have a magnetic anisotropy with an easy axis oriented perpendicular to the air bearing surface when deposited over the textured seed layer. A magnetic free layer structure formed over the pinned layer structure and over a non-magnetic barrier layer has a face centered cubic structure which causes the magnetic free layer to have a magnetic anisotropy with an easy axis oriented parallel with the air bearing surface.

### FIELD OF THE INVENTION

The present invention relates to magnetic data recording and more particularly to a read sensor structure having a pinning structure that has robust pinned layer pinning without the use of an antiferromagnetic layer, thereby achieving a reduced read gap thickness.

### BACKGROUND OF THE INVENTION

The market for information storage and recording devices is steadily expanding, supported by the development of devices that require the storage of vast amounts of data. Within these developments, demand is every growing for the development of technologies for achieving higher recording densities in Hard Disk Drives (HDDs). In the corresponding technology trends, current HDDs have moved from in-plane magnetic recording techniques to perpendicular magnetic recording techniques, and the playback magnetic head mounted in the HDD is shifting from a current-in-the-plane, giant magneto-resistive (CIP-GMR) heads to tunneling magnetoresistive (TMR) heads which have high read-out signal amplitude. From the perspective of the magnetized recording pattern recorded on a magnetic recording medium, a higher recording density in the HDD can be achieved by both narrowing the track pitch and shortening the bit length. In the pursuit of these trends, the magnetic read head must undergo nano-finishing of the track width and further narrowing of the read gap (spacing between the upper and lower shields). In the latter case, the total film thickness of the magnetic sensor film becomes the primary controlling factor. If the read gap cannot be sufficiently narrowed, that is, a thinner magnetic sensor film cannot be realized, it becomes difficult to achieve a high read-out resolution or good read-out characteristics. The structure of the magnetic sensor film of a current TMR head consists of a layered structure called a spin valve (SV) and composed of a seed layer/anti-ferromagnetic layer/ferromagnetic pinned layer/tunnel barrier layer/ferromagnetic free layer/capping layer. The anti-ferromagnetic layer plays the role of pinning the magnetization direction of the pinned layer in the desired direction. In the thin-film layer structure of the magnetic sensor film, the anti-ferromagnetic layer is the thickest film and, therefore, consumes a large portion of the read gap budget. Therefore, reducing the thickness of the AFM layer or even eliminating the AFM layer altogether can reduce the read gap and can improve areal recording density.

U.S. Pat. No. 7,800,867 discloses an example of a structure which does not have an anti-ferromagnetic layer located directly within the sensor stack. In this structure, the shape of the pinned layer extends in the stripe height direction, and the anti-ferromagnetic layer is arranged on the extended portion of the pinned layer. In this structure, although the magnetization is stable in the extended portion of the pinned layer far from the air bearing surface (ABS), there is concern about the stability of the magnetization in the pinned layer near the ABS. Another concern is that good read-out characteristics are not obtained because the stability of the magnetization of the pinned layer near the ABS significantly affects the output characteristics of the magnetic read head.

In addition, U.S. Pat. No. 7,564,659 B2 and 2008/0204945 A1 disclose techniques which provide an anisotropic texture on the seed layer by etching to assist pinning the magnetization of the pinned layer. However, the texture formed on the seed layer affects the anisotropy of the magnetization of the free layer and not just the pinned layer. In this case, simultaneously controlling the magnetization directions of the pinned layer and the free layer becomes difficult, and obtaining good read-out characteristics becomes difficult. In addition, in a spin valve magnetic sensor film having a layered structure of extremely thin films, the roughness of the layered interface causes degradation in the magnetoresistive effect (MR) characteristics and leads to an increase in the interlayer interaction between the magnetization of the pinned layer and the magnetization of the free layer. Consequently, this is undesirable from the perspectives of the read-out sensitivity and ensuring symmetry in the output.

In order for a magnetoresistive sensor to function optimally, several parameters must be controlled. First, strong pinning of the magnetization of the pinned layer should be maintained. Second, the magnetization of the free layer should be controlled in a direction perpendicular to the magnetization of the pinned layer. Third, the magnetoresistive characteristics of the sensor should be maximized and not degraded. Fourth, the interlayer interaction between the pinned and free layers should be minimized.

Previous attempts at minimizing the gap thickness, such as by reducing or eliminating the AFM layer in the sensor stack, have not been able to achieve all of these goals. Therefore, there remains a need for a magnetoresistive sensor structure that can minimize the gap thickness for increased areal recording density, while also maintaining the above discussed design goals.

### SUMMARY OF THE INVENTION

The present invention provides a magnetic read sensor that includes a seed layer having a surface formed with an anisotropic texture. A pinned layer structure is formed over the seed layer, and at least a portion of the pinned layer comprises a material having a body centered cubic crystalline structure. A non-magnetic layer is formed over the pinned layer structure, and a magnetic free layer structure is formed over the non-magnetic layer, the free layer having a face centered cubic crystalline structure.

The present invention can be implemented in a spin valve magnetic sensor film without an anti-ferromagnetic layer and having a pinned layer with a self-pinned structure by: (1) forming an anisotropic texture having periodic undulations in the stripe height direction on a seed layer; (2) forming a pinned layer from a material having the main constituent of Co—Fe having a body-centered cubic (BCC) structure in at least one part, and forming a free layer from a material having the main constituent of Co—Fe or Ni—Fe having a face-centered cubic (FCC) structure in at least one part; (3) shaping the pinned layer to extend further than the free layer in the stripe height direction; (4) forming an anti-ferromagnetic layer on the extended portion of the pinned layer; and (5) in an appropriate step for a sensor film layering process, conducting an appropriate smoothing or planarizing process by plasma irradiation having small energy and producing a smaller amplitude of the undulations directly under the barrier layer than the amplitude of the undulations directly on the formed texture. Items (1) to (4) give uniaxial magnetic anisotropy which sets the stripe height direction as the easy axis of magnetization, shape magnetic anisotropy, and unidirectional magnetic anisotropy to the pinned layer. The magnetization direction can be firmly pinned in the desired orientation. The origins of the provided magnetic anisotropies are the anisotropic crystal orientation growth corresponding to the texture formed on the seed layer, the device shape having a high aspect ratio (stripe height/track width), and the exchange coupling in the adjacent (ferromagnetic layer/) anti-ferromagnetic layer. However, (4) is not necessarily needed to assist pinning. Simultaneously, uniaxial magnetic anisotropy where the track width is the easy axis of magnetization is induced in the free layer having an FCC structure. The origin of this depends on the anisotropic crystal orientation growth corresponding to the texture formed on the seed layer. As a result, preferably, the magnetizations of the pinned layer and the free layer can be oriented orthogonal to one another. In addition, the roughness of the layered film affects the magnetoresistive effect (MR) characteristics affecting the read-out output because the tunnel barrier layer is composed of extremely thin films usually having a thickness less than 1 nm. Consequently, the smoothing or planarizing process (item (5) above) can reduce degradation in the MR characteristics caused by the roughness from the texturing of the seed layer. Simultaneously, ensuring the symmetry of the output is also effective because the increase in the magnetic interlayer interaction acting between the pinned layer and the free layer can be suppressed by reducing this roughness. A process of the present invention advantageously promotes anisotropic crystal growth while the directional vibrations are maintained along the texture direction needed to induce uniaxial magnetic anisotropy in the pinned layer and the free layer while decreasing the roughness amplitude in the film thickness direction so that good MR characteristics are ensured.

The present invention provides a structure which can control the direction of magnetization of the pinned layer which has sufficient robustness to disturbance such as external magnetic fields and the ambient temperature changes without degrading the MR characteristics and which maintains an orthogonal arrangement of the magnetizations of the pinned layer and the free layer in an SV structure and which does not include an anti-ferromagnetic layer directly within the spin valve stack where it would cause an increase in gap thickness. According to an aspect of the present invention, a read gap length (gap between the upper and lower shields) less than 18 nm can be achieved, and a sufficiently high resolution can be obtained even when the areal recording density exceeds 1 Tbit/inch². In addition, in a structure of the present invention, the increased output resulting from improved utilization and a higher resolution can be obtained because the position offset of the free layer from the center position of the read gap can be decreased while also maintaining a sufficiently narrow read gap length. Furthermore, noise can be reduced and stable read-out characteristics can be obtained because the magnetization of the pinned layer can be strongly pinned, and the orthogonal arrangement of the magnetizations of the pinned layer and the free layer can be achieved.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is an air bearing surface view of a magnetic sensor according to an embodiment of the invention;

FIG. 4 is a side cross sectional view of the magnetic sensor of FIG. 3;

FIG. 5 is a side cross sectional view of another magnetic sensor of FIG. 3;

FIGS. 6-23 are views of a magnetic sensor in various intermediate stages of manufacture, illustrating a method of manufacturing a magnetic sensor according to an embodiment of the invention;

FIGS. 24-27 are views of a magnetic sensor in various intermediate stages of manufacture, illustrating a method of manufacturing a magnetic sensor according to an alternate embodiment of the invention; and

FIGS. 28-31 are views of a magnetic sensor in various intermediate stages of manufacture, illustrating a method of manufacturing a magnetic sensor according to still another embodiment of the invention.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

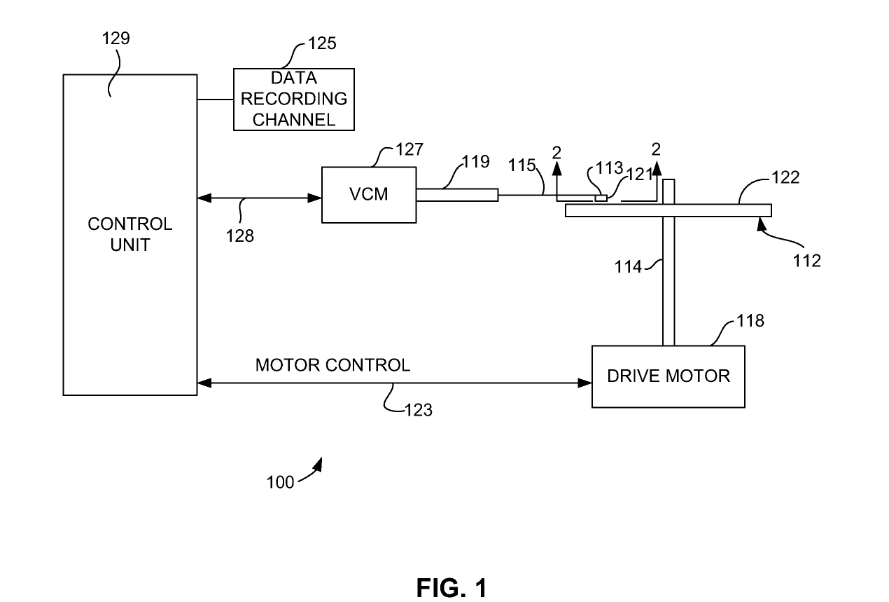

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

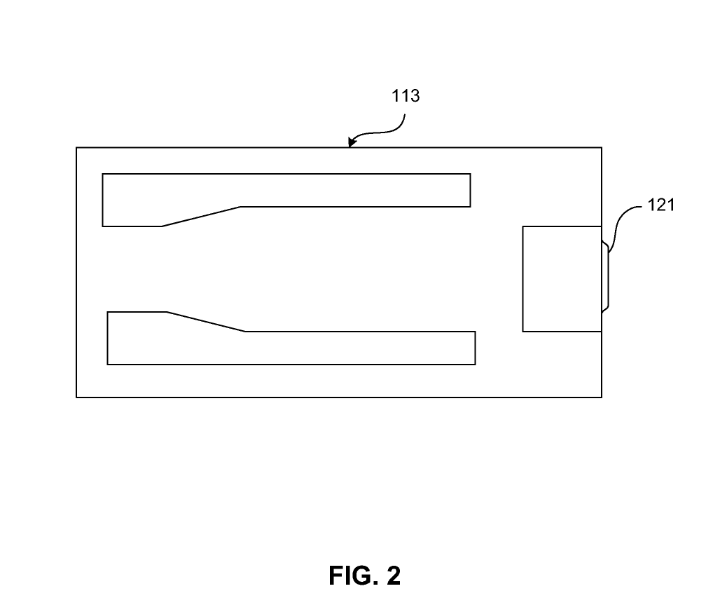

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

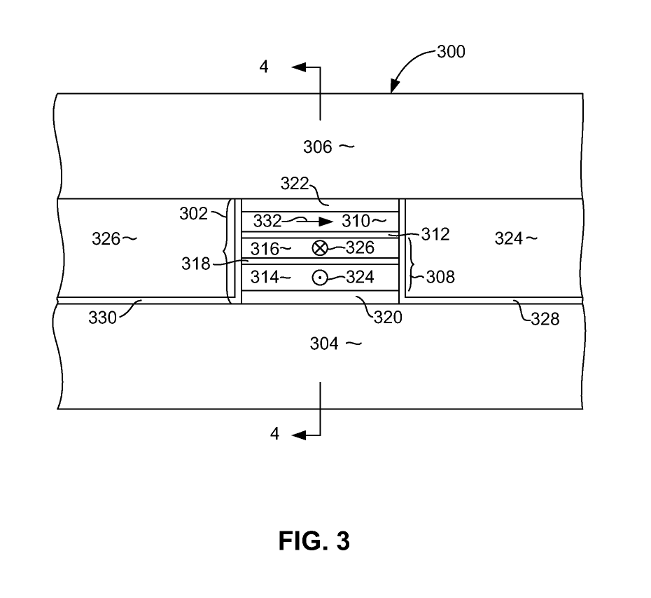

FIG. 3 shows view of a magnetic read head 300 as viewed from the air bearing surface (ABS) or along a plane that is parallel with the ABS. The read head 300 includes a sensor stack 302 that is sandwiched between lower and upper magnetic shields 304, 306. The magnetic shields 304, 306 are constructed of a magnetic, electrically conductive material such as NiFe so that they may function as electrically conductive leads as well as functioning as magnetic shields.

The sensor stack 302 includes a magnetic pinned layer structure 308, a magnetic free layer structure 310 and a thin, non-magnetic, electrically insulating barrier layer 312 sandwiched between the pinned layer structure 308 and the free layer structure 310. The pinned layer structure 308 includes a first magnetic layer 314, and a second magnetic layer 316, both of which are magnetically anti-parallel coupled with one another by a non-magnetic anti-parallel coupling layer 318, such as Ru. The first magnetic layer is formed upon a metal seed layer 320. The seed layer 320 is preferably formed of Ru. The structure of the pinned layer structure 308, the free layer structure 310 and the seed layer 320 will be discussed further herein below. The sensor stack may also include a capping layer 322 formed above the free layer 310. The capping layer can be constructed of one or more material such as Ta and acts to protect the under-lying layers of the sensor stack 302 during manufacture.

With continued reference to FIG. 3, first and second hard magnetic bias layers 324, 326 are formed at each side of the sensor stack 302. Thin insulation layers 328, 330, constructed of a thin layer of non-magnetic, electrically insulating material such as alumina are formed at either side of the sensor stack 302. The insulation layers 328, 330 are formed between the hard bias layers 324, 326 and the sensor stack and also between the hard bias layers 324, 326 and the first magnetic shield 304 to prevent sense current from being shunted through the hard bias layers 324, 326 during operation.

The hard bias layers 324, 326 bias the magnetization of the free layer 310 in a direction that is substantially parallel with the ABS as indicated by arrow 332. Although the magnetization 332 of the free layer 310 is biased in a direction parallel to the ABS, this magnetization can move from this position in response to an external magnetic field, such as from a magnetic medium. In addition, the first and second magnetic layers 314, 316 of the pinned layer structure 308 are pinned in antiparallel directions that are perpendicular to the ABS as indicated by arrowhead symbol 324 arrow tail symbol 326. The pinning of the magnetizations 324, 326 of the pinned layer structure 308, as well as the biasing of the magnetization 332 of the free layer 310 will be discussed in further detail herein below.

In FIG. 3, it can be seen that the pinned layer structure 308 has no layer of antiferromagnetic material (e.g. no AFM layer) to pin the first magnetic layer 314. The pinned layer structure 308 is, therefore, self pinned. This greatly reduces the spacing between the shields 304, 306. In order for an AMF layer to effectively pin a magnetic pinned layer the AFM layer must be made very thick relative to the thicknesses of the other layers. Therefore, constructing the sensor 300 as a self pinned structure, without the need for an AFM layer, greatly decreases the read gap (spacing between the shields 304, 306) and therefore, allows for greatly increased areal recording density in the disk drive system.

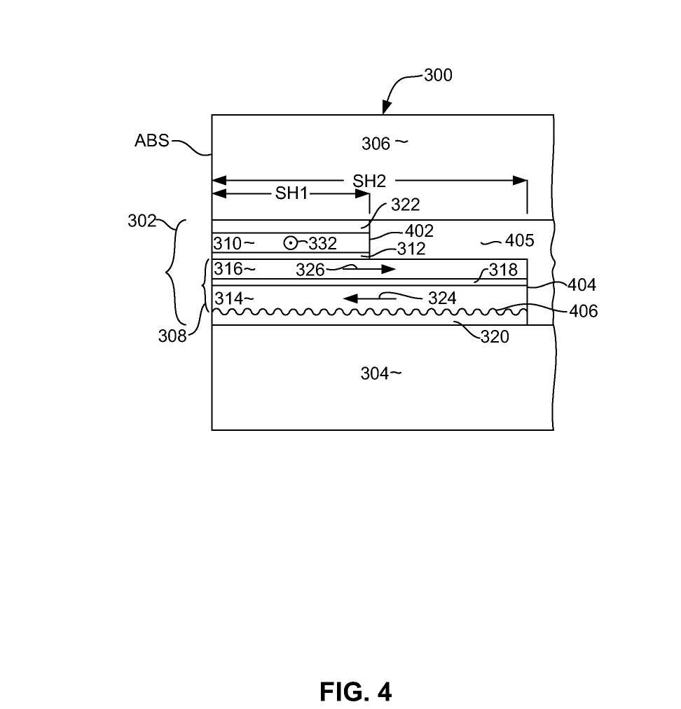

FIG. 4 shows a side cross section view of the read head 300 as seen from line 4-4 of FIG. 3. In FIG. 4 it can be seen that the free layer 310, capping layer 322 and all or a portion of the barrier layer 312 extend from the ABS to a first back edge 402 by a distance that defines a first stripe height SH1. The pinned layer structure 308 and seed layer 320 extend further from the ABS to a second back edge 404 that defines a second stripe height distance SH2. While the first stripe height SH1 defines the stripe height of the sensor for purposes of sensor performance such as free layer sensitivity, the second stripe height SH2 of the pinned layer structure 308 provides the pinned layer structure 308 with a shape enhanced magnetic anisotropy having an easy axis of magnetization that is oriented in a direction perpendicular to the ABS. This assists in maintaining the pinning of the magnetizations 324, 326 of the pinned layer in a direction perpendicular to the ABS. The space behind the back edge 402 between the pinned layer structure 308 and the upper shield 306 can be a non-magnetic, electrically insulating fill layer 406 such as alumina.

In addition, it can be seen that the seed layer 320 has an upper surface that is formed with an anisotropic texture that can be configured as periodic ripples or facets 406 that extend along a direction parallel with the ABS and have a period of repetition in a direction perpendicular to the ABS. This anisotropic texture of the seed layer 320 generates a strong magnetic anisotropy in the magnetic layers 314, 316 of the pinned layer structure, resulting in a magnetic easy axis that is oriented in a direction perpendicular to the ABS and a magnetic hard axis in a direction parallel with the ABS.

The anisotropic texture of the seed layer 320 affects the grain growth of the layers deposited, providing the desired magnetic anisotropy in the pinned layers 314, 316. This texture, however, also affects the layers formed above the pinned layer structure 308. While is it is desirable for the pinned layers 314, 316 to have a magnetic anisotropy with an easy axis oriented perpendicular to the ABS, it is undesirable for the free magnetic layer structure 310 to have a magnetic anisotropy with an easy axis oriented perpendicular to the ABS. In fact, to promote magnetic stability of the free layer 310 it is desirable that the free layer have a magnetic anisotropy with an easy axis oriented parallel with the ABS (parallel with the direction of magnetization 332). The present invention advantageously allows the textured surface of the seed layer 320 to promote a magnetic anisotropy with an easy axis perpendicular to the ABS for the pinned layers 314, 316, while maintaining a desired magnetic anisotropy in the free layer 310 with an easy axis parallel with the ABS.

First with regard to the magnetic layers of the pinned layer structure 308, in order for the textured surface of the seed layer 320 to generate a magnetic anisotropy in the layers 314, 316, one or both of these layers 314, 316 is at least partially composed of CoₓFe_{y} where x is no greater than 60 atomic percent. This causes the layers 314, 316 to have a body centered cubic (BCC) crystalline structure which has a desired magnetic anisotropy with an easy axis perpendicular to the ABS when formed on the textured seed layer 320. Preferably, the at least one of the layers 314, 316 is at least partially comprised of CoₓFe_{y} where x is 40-60 atomic percent or more preferably about 50 atomic percent. Other constituent elements could be included as well. Therefore, at least one of the layers 314, 316 preferably comprises Co₅₀Fe₅₀ or Co₄₀Fe₄₀B₂₀. As used herein, the subscripts listed in the alloy designations refer to the alloy element concentrations in atomic percent.

Whereas the pinned layer comprises a magnetic material having a BCC structure as discussed above, the free layer 310, by contrast, comprises a magnetic material having a face centered cubic (FCC) structure. This FCC structure produces a magnetic anisotropy in the free layer 310 that has a magnetic easy axis oriented parallel with the ABS and a magnetic hard axis that is oriented perpendicular to the ABS as desired when the free layer 310 is formed in a sensor stack having the seed layer 320 with the described anisotropic texture. Therefore, the texture of the seed layer 320 produces a magnetic anisotropy in the pinned layer 308 having an easy axis perpendicular to the ABS while producing a magnetic anisotropy in the free layer 310 that has an easy axis oriented parallel with the ABS as desired. It can be seen, then, that the magnetic anisotropies of the pinned layer 308 and free layer 310 are orthogonal to one another.

To this end, the free layer 310 can be constructed at least partially of CoFe having a Co concentration greater than 80 atomic percent, can be constructed of CoFeB having a Co concentration greater than 60 atomic percent or can be constructed of NiFe. More preferably, the free layer 310 is constructed of Co₉₀Fe₁₀, Co₇₂Fe₈B₂₀ or Ni₈₅Fe₁₅. These materials have the desired FCC crystalline structure while also having good magnetic properties for use in the free layer 310.

Describing the structure in even greater detail, in one embodiment of the invention the seed layer 320 can be constructed of Ru having a thickness of about 1 nm. The first layer 314 of the pinned layer structure 308 can be constructed of Co₅₀Fe₅₀ having a thickness of about 2.0 nm. The antiparallel coupling layer 318 can be constructed of Ru having a thickness of 0.35 nm. The second magnetic layer 316 of the pinned layer structure 308 can be constructed of Co₄₀Fe₄₀B₂₀ having a thickness of about 2.2 nm. The barrier layer 312 can be constructed of MgO having a thickness of about 0.8 nm. The free layer 310 can be constructed as a tri-layer structure, including a first layer located closest to the barrier layer 312, a second layer formed over the first layer and a third layer formed over the second layer, such that the second layer is between the first and third layers. The first layer of the free layer 310 can be constructed of Co₉₀Fe₁₀ having a thickness of about 1 nm. The second layer of the free layer 310 can be constructed of Co₇₂Fe₈B₂₀ having a thickness of about 2 nm, and the third layer of the free layer 310 can be constructed of Ni₈₅Fe₁₅ having a thickness of about 2 nm. The capping layer 322 can be constructed as a bi-layer structure including a first layer (located closest to the free layer 310) constructed of Ru having a thickness of about 3 nm, and a second layer formed over the first layer and constructed of Ta having a thickness of about 2 nm. The compositions listed here are in atomic percent.

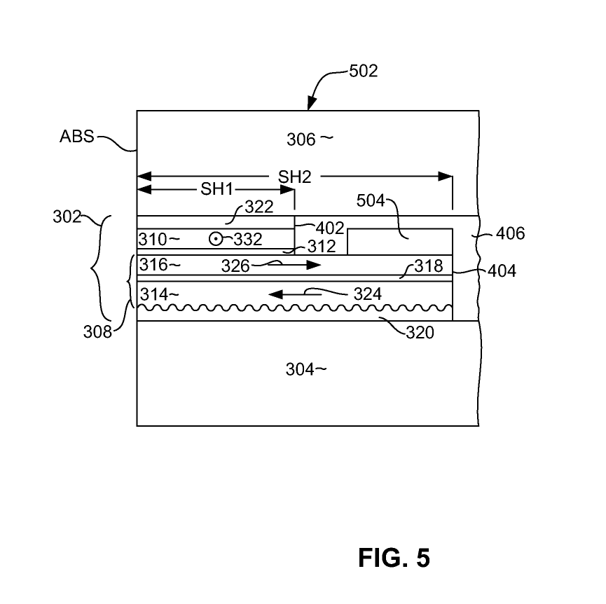

The combined effect of the shape enhanced magnetic anisotropy in the pinned layer structure 308, the magnetic anisotropy resulting from the textured surface of the seed layer 320 and the antiparallel magnetic coupling between the magnetic layers 314, 316 across the antiparallel coupling layer 318 result in strong pinning of the magnetizations 324, 326 of the pinned layer structure 308, without the need for an layer of antiferromagnetic material. However, FIG. 5 illustrates an alternate embodiment that can be useful in situations where further additional pinning strength and reliability are required.

With reference then to FIG. 5, a read head 502 can be formed, which is similar to that of FIG. 4, except that a layer of antiferromagnetic material (AFM structure 504) is formed behind the back edge 402 of the free layer 310. This AFM layer 504 contacts and is exchange coupled with the second magnetic layer 316 of the pinned layer structure 308. This AFM layer 504 is contained within the space between the pinned layer structure 308 and the upper shield 306. Therefore, the AFM layer 504 does not add to the read gap thickness (e.g. space between the upper and lower shield 304, 306. The exchange coupling between the AFM layer 504 and the back extending portion of the pinned layer 316 strongly pins the magnetization 326 of this layer 316 in this back region, thereby preventing the magnetizations 324, 326 from flipping direction.

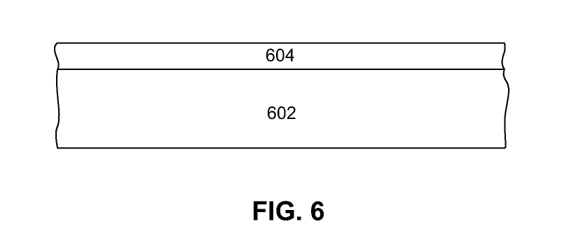

With reference to FIGS. 6-23, a method is described for manufacturing a magnetic read head 300 such as that described above with reference to FIGS. 3 and 4. With particular reference to FIG. 6 a first shield 602 is formed. The shield 602 can be formed of an electrically conductive, magnetic material such as NiFe, which can be formed by electroplating or sputter deposition. Then, a metal seed layer 604 is formed over the shield 602. The metal seed layer 604 is deposited. The seed layer 604 include one or both of Ru and Ta and can be deposited as a layer of Ta having a thickness of about 1 nm and a layer of Ru deposited over the layer of Ta and having a thickness of about 12 nm. Alternatively, the seed layer 604 can be deposited as a layer of Ta having a thickness of about 3 nm and a layer of Ru deposited over the layer of Ta and having a thickness of about 2 nm.

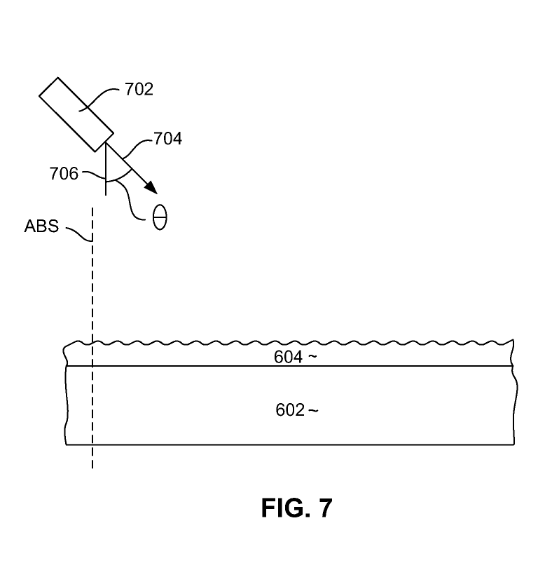

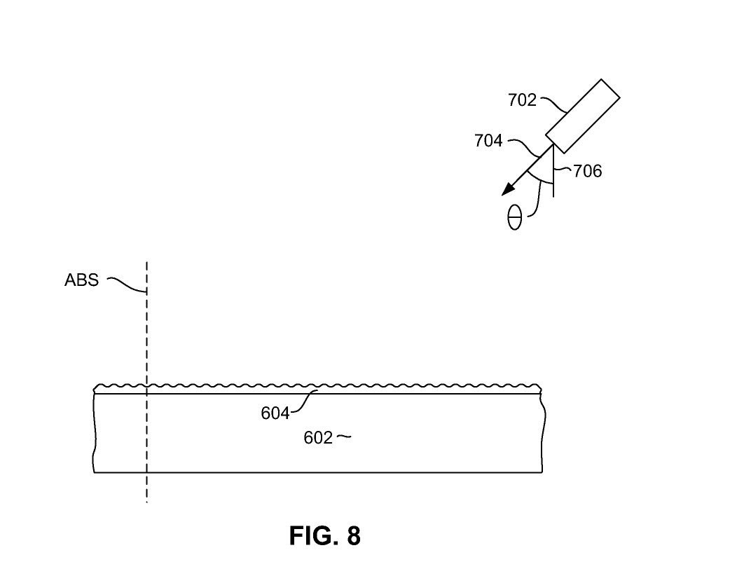

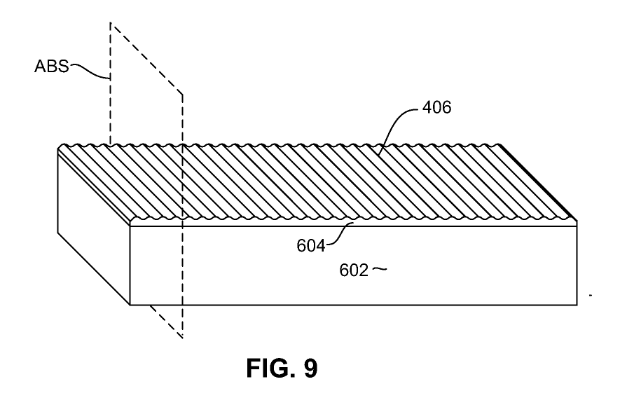

After depositing the seed layer 604, the seed layer is treated to form it with a desired anisotropic texture. With reference to FIG. 7, an angled ion milling is performed, using an ion beam gun 702 to direct an ion beam 704 toward the wafer (not shown) on which the shield 602 and seed layer 604 are formed. The ion beam 704 is bombarded at an angle θ relative to normal. The term normal as used herein refers to the a line 706 that is perpendicular to the planes of the as deposited shield 602 and seed layer 604 and normal to the substrate (not shown) on which the shield 602 and seed layer 604 are formed. The angle θ is preferably about 60 degrees. The ion beam etching is performed for a desired durations, such as about 30 seconds. While not shown herein, the ion milling can be performed in an ion milling tool that includes a chamber (not shown), the ion gun 702 and a chuck (not shown) on which a wafer (not shown) on which the shield 602 and seed layer 604 are formed. As shown in FIG. 7, the angled ion milling results in the formation of an anisotropic texture on the surface of the seed layer. However, since the ion milling is being performed from one side as shown in FIG. 7, the resulting texture may not be symmetrical. Therefore, in order make ensure that the ion milling is performed symmetrically, the wafer (not shown) can be rotated 180 degrees. Then, a second ion milling can be performed from the opposite side as shown in FIG. 8. The first and second ion millings can be performed and/or repeated until the thickness of the seed layer is reduced to a nominal thickness of about 2 nm, and can be formed with ripples or undulations that have a period of about 10 nm and an amplitude of about 1 nm. Preferably, the surface texture of the seed layer 604 after ion milling is such that the stripe height of the sensor (defined at a later stage of manufacture) stripe height is sufficiently larger than the period of the undulations. For example, the stripe height can be about 100 nm, whereas the period of the undulations is about 10 nm as discussed above. FIG. 9 shows a perspective view of the shield 602 and seed layer 604, and shows in greater detail how the anisotropic texture of the seed layer is formed as ripples 406 that run substantially parallel with the air bearing surface plane, and having a periodicity that is substantially perpendicular the air bearing surface plane. Although the air bearing surface plane is not yet formed at this stage of manufacture, the orientation of the intended air bearing surface plane is represented by dashed line ABS in FIG. 9.

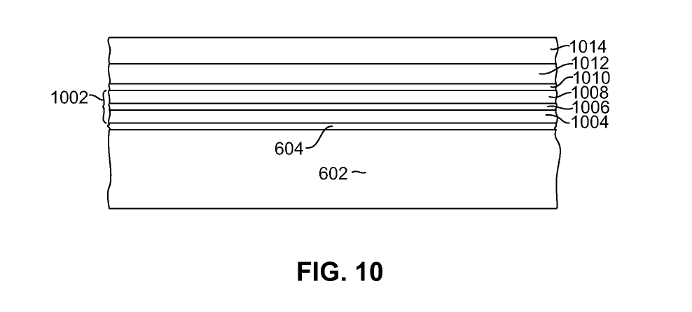

After the seed layer 604 has been textured as described above, the rest of the sensor layers can be deposited. With reference to FIG. 10, a pinned layer structure 1002 is deposited over the seed layer 604. The deposition of the pinned layer structure 1002 includes depositing a first magnetic layer 1004, depositing a non-magnetic anti-parallel coupling layer such as Ru 1006 over the first magnetic layer 1004 and depositing a second magnetic layer 1008 over the non-magnetic ant-parallel coupling layer 1006. At least one of the magnetic layers 1004, 1008 is constructed of a magnetic material having a body centered cubic (BCC) structure. To this end, at least one of the layers 1004, 1008 can be constructed of CoFe having 40-60 atomic percent Co or about 50 atomic percent Co. More preferably, the first magnetic layer 1004 is formed of CoFe having about 50 atomic percent Co and about 50 atomic percent Fe and having a thickness of about 2.0 nm. The anti-parallel coupling layer 1006 is preferably constructed of Ru having a thickness of about 0.35 nm. The second magnetic is preferably constructed of CoFeB having about 40 atomic percent Co about 40 atomic percent Fe and about 20 atomic percent B and having a thickness of about 2.2 nm.

With continued reference to FIG. 10, a non-magnetic layer 1010 is deposited over the pinned layer structure 1002. The non-magnetic layer 1010 can be a thin, electrically insulating barrier layer that can be constructed of an oxide such as MgO and can be deposited to a thickness of about 0.8 nm. Alternatively, if the sensor is to be a GMR sensor, the non-magnetic layer 1010 can be an electrically conductive material such as Cu.

At some point prior to depositing the non-magnetic barrier layer 1010, a smoothing or planarizing process can be performed to reduce the roughness caused by the texturing of the seed layer 604, thereby reducing the roughness of the non-magnetic barrier layer 1010. This smoothing or planarizing can be achieved, for example by performing a low power ion irradiation on one of the layers of the pinned layer structure 1002. Reducing the roughness prior to depositing the barrier layer 1010 advantageously reduces inter layer coupling between the free and pinned layer structures 1012, 1002, and also prevents the formation of voids or pin-holes in the barrier layer 1010.

A free layer structure 1012 is then deposited over the non-magnetic layer 1010. The free layer structure 1012 can be formed by depositing more than one layer of magnetic material, however, the free layer preferably includes at least a layer of material having a face centered cubic (FCC) structure such as a CoFe alloy having 85-95 atomic percent Co. More particularly, the free layer 1012 can be deposited by first depositing a first layer of CoFe having about 90 atomic percent Co and about 10 atomic percent Fe and having a thickness of about 1 nm. This first layer can be deposited directly on top of non-magnetic layer 1012. A second layer can then be deposited directly over the first layer, the second layer being a Co—Fe—B alloy having about 72 atomic percent Co, about 8 atomic percent Fe and about 20 atomic percent B and being deposited to a thickness of about 2 nm. A third layer can then be deposited over the second layer, the third layer being a Ni—Fe alloy having about 85 atomic percent Ni and about 15 atomic percent Fe and being deposited to a thickness of about 2 nm. The deposition of the first, second and third layer can, thereby, form a free layer according to a possible embodiment of the invention.

Then, with continued reference to FIG. 10, a capping layer structure 1014 can be deposited over the free layer structure 1012. The capping layer can be a bi-layer that includes a layer of Ru and a layer of Ta deposited over the layer of Ru. However, other structures could be used for the capping layer. Therefore, according to one possible embodiment of the invention, the capping layer 1014 can be formed by first depositing a layer of Ru to a thickness of about 3 nm, and then depositing a layer of Ta over the layer of Ru. The Ta layer can be deposited to a thickness of about 2 nm. All of the layers 1004, 1006, 1008, 1010, 1012 and 1014 can be deposited by sputter deposition in a sputter deposition tool.

A high temperature annealing process can be performed to set the magnetization of the pinned layer 1002 in a desired direction. This can be achieved increasing the temperature and exposing the pinned layer 1002 to a magnetic field that sets the magnetization of the pinned layer structure 1002.

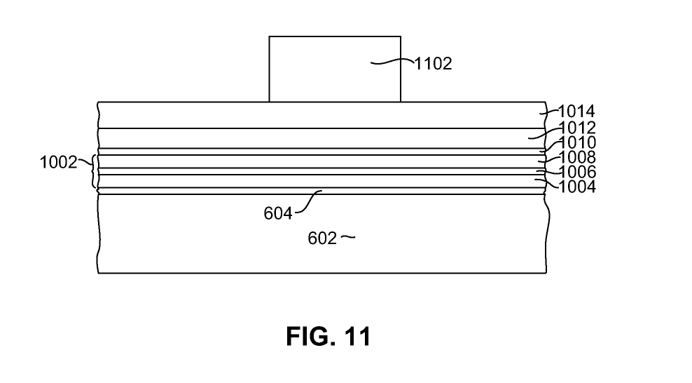

FIG. 11 shows a view of a plane that is parallel with an intended air bearing surface plane. With reference to FIG. 11, a first mask 1102 is formed. This first mask is configured to define a track-width of the sensor. Although shown as a single layer 1102 in FIG. 11, the mask 1102 can actually include several layers such as one or more hard mask layers, an image transfer layer, a bottom anti-reflective coating layer and a layer of photoresist that has been photolithographically patterned and developed. In such a multi-layer mask structure the layer of photoresist (not shown) could be photolithographically patterned to define a desired mask shape, and the pattern of the photoresist mask could be transferred onto the underlying mask layers (also not shown) by one or more reactive ion etching and/or ion milling processes.

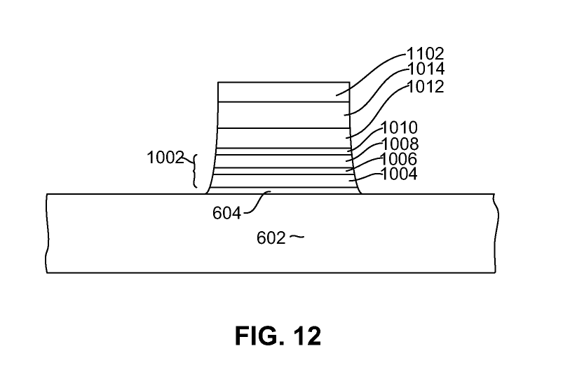

With reference now to FIG. 12, an ion milling process is performed to remove portions of the mask layers 604, 1004, 1006, 1008, 1010, 1012, 1014 that are not protected by the mask 1102, thereby defining a sensor track-width. The ion milling may also remove a portion of the mask 1102, so that the mask after ion milling may not be as tall as it was before the ion milling.

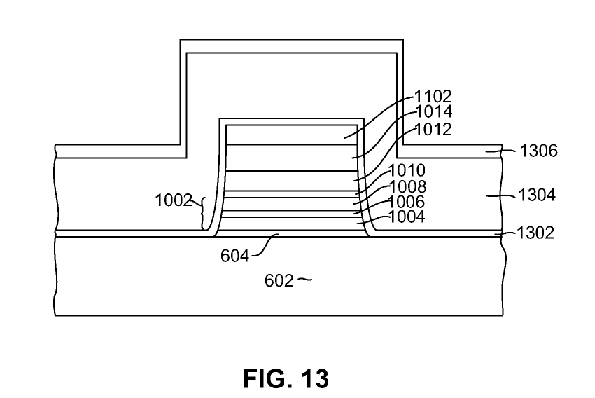

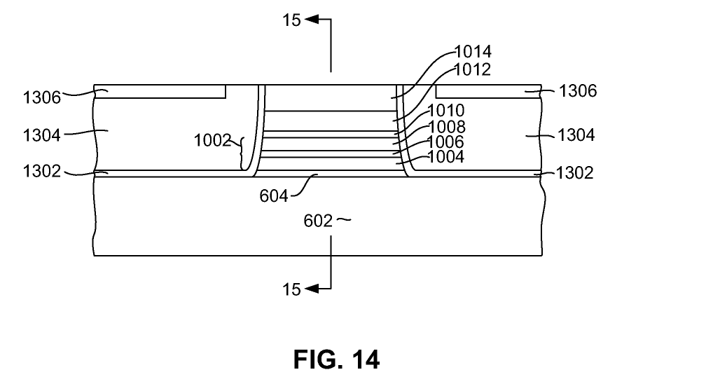

Then, with reference to FIG. 13, a thin layer of insulation 1302 is deposited followed by a layer or hard magnetic bias material 1304, followed by a non-magnetic, physically hard protective layer 1306. The insulation layer 1302 can be a material such as alumina (Al₂O₃), which can be deposited by a conformal deposition process such as atomic layer deposition. The hard magnetic bias layer 1304 can be a magnetic material having a high magnetic coercivity such as CoPt or CoPtCr. The protective layer 1306 can be a material such as Ru or could be diamond like carbon (DLC). The mask 1102 can then be lifted off and a planarization process such as chemical mechanical polishing can be performed leaving a structure such as that shown in FIG. 14.

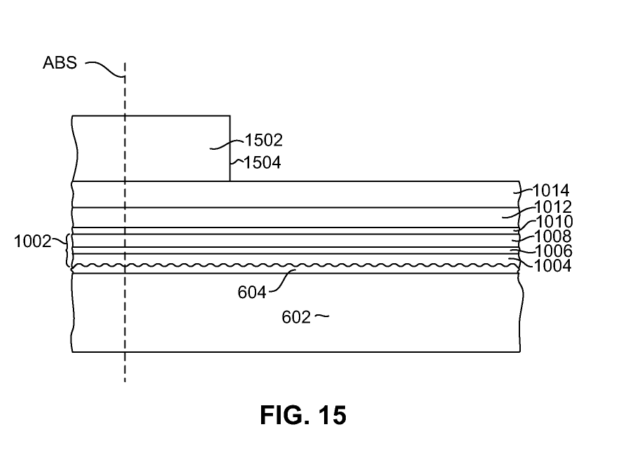

FIG. 15 shows a side cross sectional view as seen from line 15-15 of FIG. 14. The view in FIG. 15 is a cross section that is perpendicular to the air bearing surface plane. Although the air bearing surface has not yet been formed at this stage of manufacture, the intended locations of an air bearing surface plane in FIG. 15 is denoted by dashed line denoted ABS in FIG. 15. As shown in FIG. 15, a second mask structure 1502 is formed having a back edge 1504 that will define a functional stripe height of the sensor, as will be seen. The mask 1504 may include various layers that are not shown, such as one or more hard mask layers an image transfer layer, a bottom anti-reflective coating layer and a photoresist layer. The mask 1502, is however shown as a single layer for purposes of clarity.

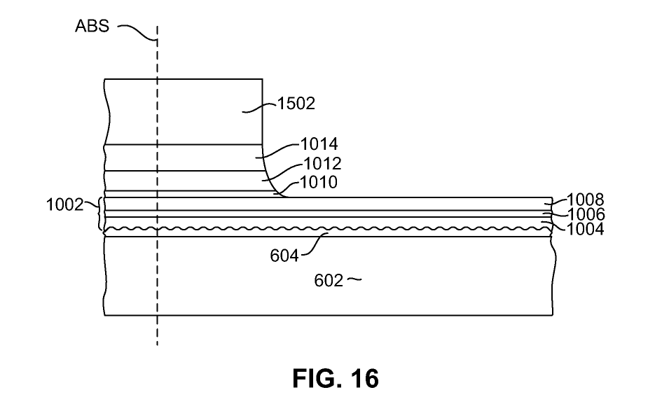

Then, with reference to FIG. 16, an ion milling is performed to remove portions of the capping layer 1014 and free layer 1012 that are not protected by the mask 1502. The ion milling can be terminated when the non-magnetic layer 1010 has been reached or when the upper magnetic layer 1008 of the pinned layer structure 1002 has just been reached. An end point detection method such as Secondary Ion Mass Spectroscopy (SIMS) can be used to determine when ion milling should be terminated. As can be seen, this leaves the pinned layer structure 1002 extending beyond the back edge of the free layer. This ion milling step defines a functional stripe height of the sensor by defining the stripe height of the free layer 1012.

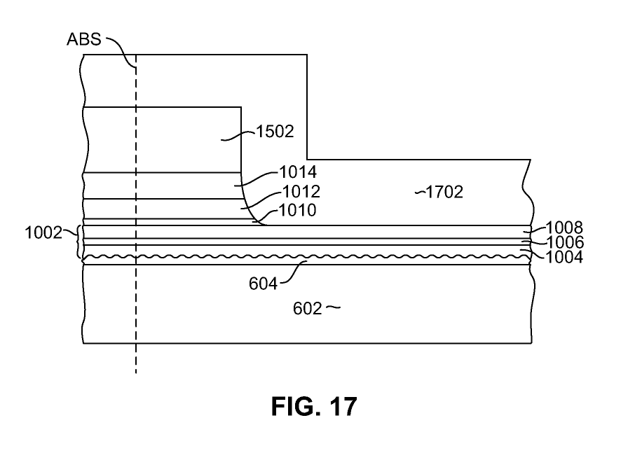

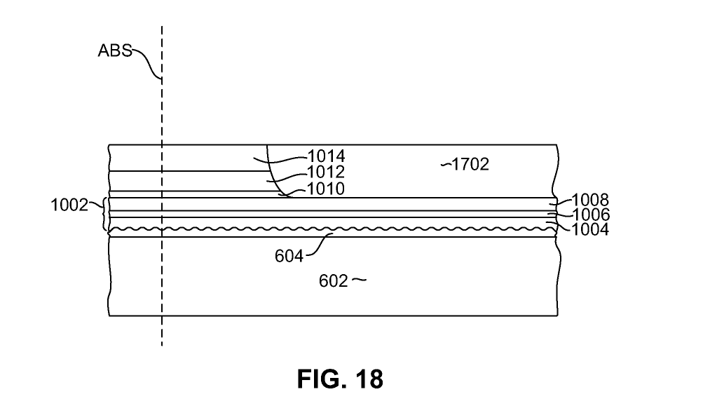

Then, with reference to FIG. 17, a non-magnetic, electrically insulating fill layer 1702 is deposited. This fill layer 1702 can be a material such as alumina (Al₂O₃). The insulation layer 1702 is deposited to a nominal thickness that is about equal with the height of the sensor layers 1010, 1012, 1014. A chemical mechanical polishing can then be performed to remove the mask 1502 and to planarize the structure leaving a structure as shown in FIG. 18.

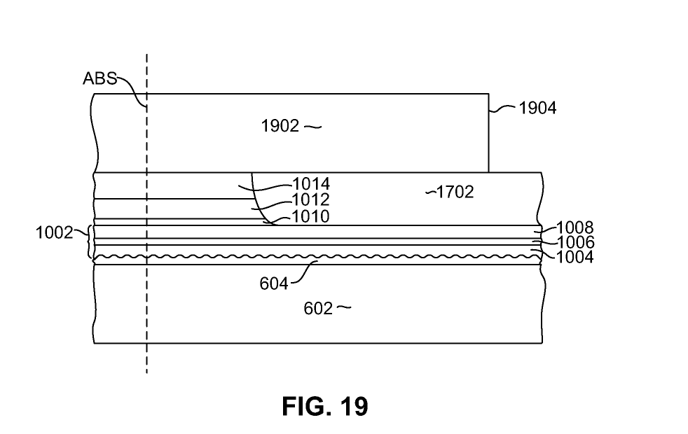

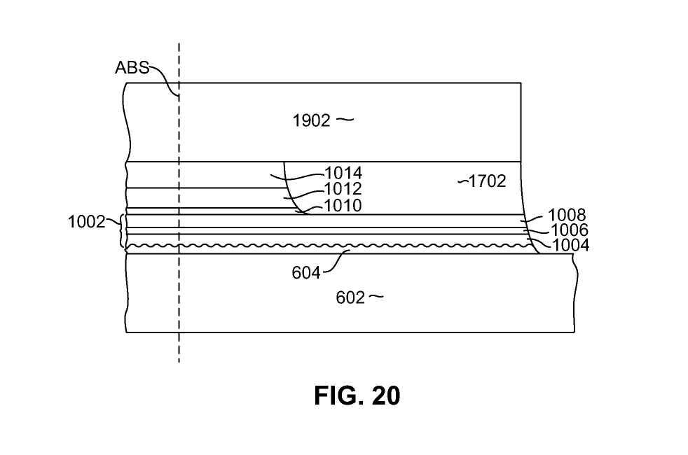

With reference now to FIG. 19, a third mask 1902 is formed, having a back edge 1904 that is configured to define a stripe height of the pinned layer structure as will be seen. Again, the mask 1902 can include various layers such as hard mask layers, image transfer layers, bottom anti-reflective coating layer and a photoresist layer, but is shown as a single layer for purposes of simplicity. Then, with reference to FIG. 20, another ion milling is performed to remove portions of the fill layer 1702 and pinned layer structure 1002 that are not protected by the mask 1902, leaving a structure as shown in FIG. 20. The ion milling can also be performed sufficiently to remove the seed layer 604, stopping at the shield 602.

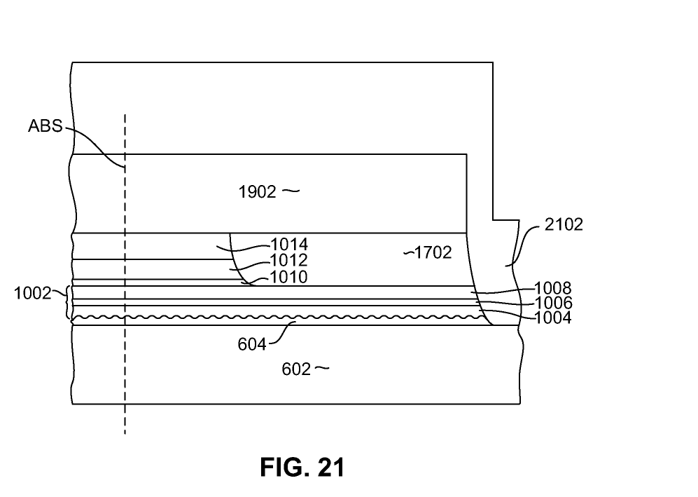

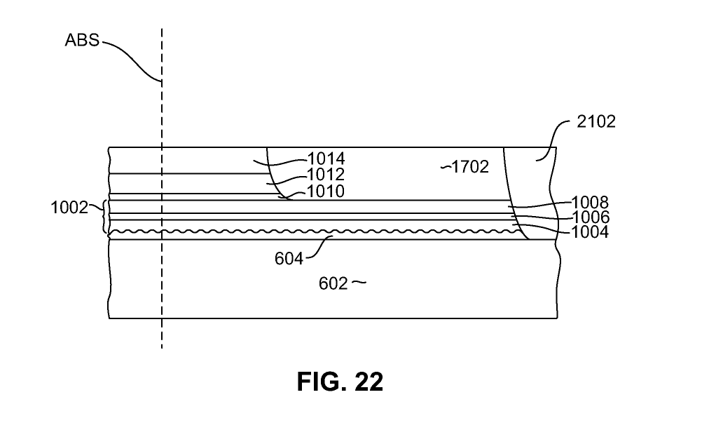

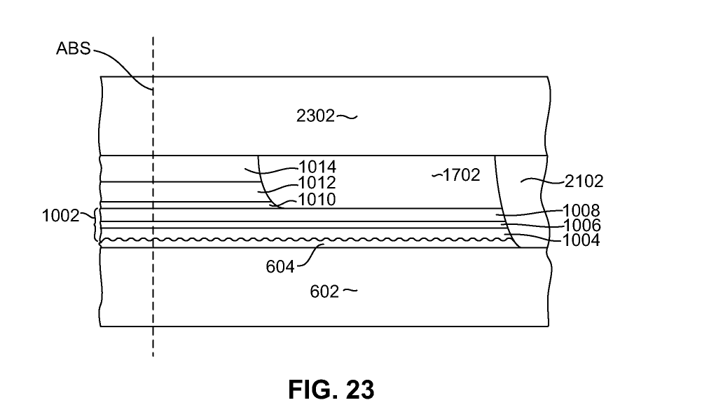

Then, with reference to FIG. 21, another layer of electrically insulating fill material 2102 is deposited. Again, the fill material can be alumina (Al₂O₃) and can be deposited to a thickness that is about equal with the thickness of the first fill layer 1702. A chemical mechanical polishing process CMP can then be performed to remove the mask 1902, leaving a structure as shown in FIG. 22. Then, with reference to FIG. 23, an upper magnetic, electrically conductive shield 2302 can be formed. The upper shield 2302 can be formed by electroplating a material such as NiFe.

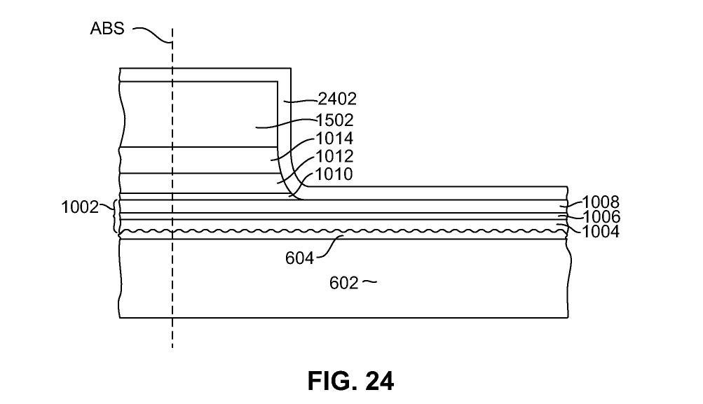

FIGS. 24-27 illustrate a method for manufacturing a magnetic read sensor according to another embodiment of the invention. Beginning with a structure as described above with reference to FIG. 16, relatively thin layer of electrically insulating, non-magnetic material such as alumina (Al₂O₃) 2402 is deposited by a conformal deposition method such as atomic layer deposition (ALD), leaving a structure as shown in FIG. 24.

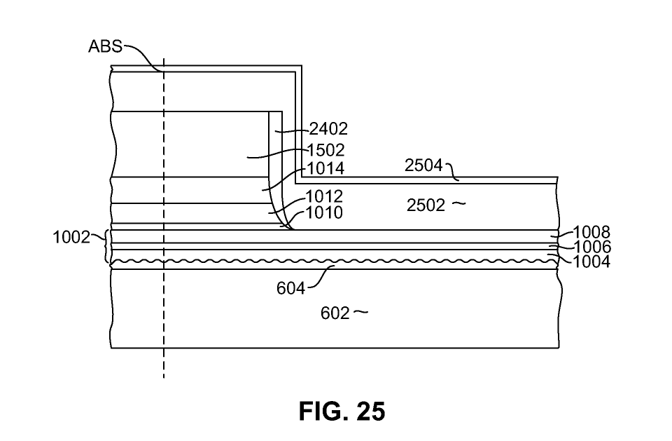

Then, with reference to FIG. 25, a directional material removal process such as ion milling is performed to preferentially remove horizontally disposed portions of the insulation layer 2402 leaving an insulating side wall of the material 2402 on the back edge of the free layer 1012 and capping layer 1014, and leaving the backward extending portion of the pinned layer 1008 exposed. A layer of antiferromagnetic material 2502 such as PtMn or IrMn is then deposited over the exposed portion of the pinned layer. A protective layer 2504 such as Ru is then deposited over the layer of antiferromagnetic material 2502.

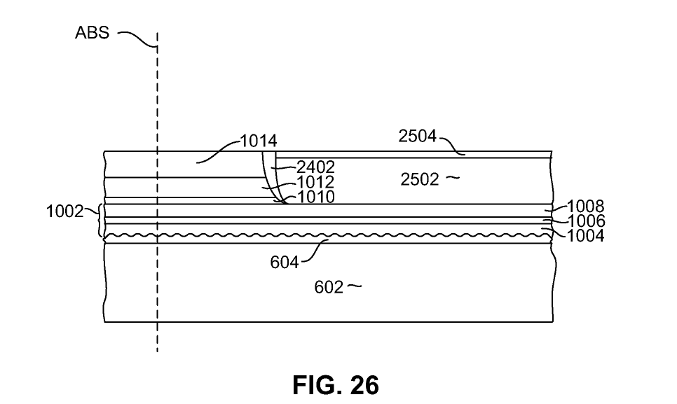

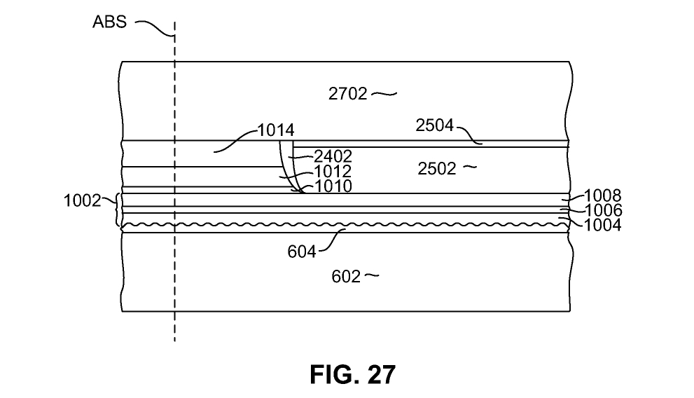

Then, a chemical mechanical polishing process (CMP) is performed leaving a structure as shown in FIG. 26. An upper magnetic, electrically conductive shield 2702 can then be formed by electroplating a material such as NiFe as shown in FIG. 27.

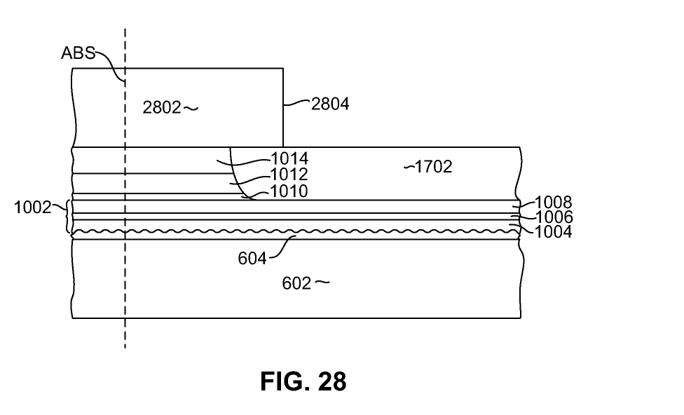

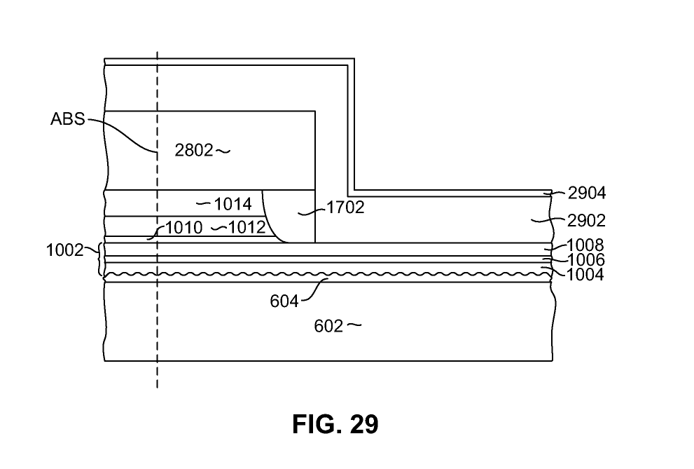

FIGS. 28-31 illustrate yet another method for manufacturing a magnetic read head according to an embodiment of the invention. Beginning with a structure such as that described above with reference to FIG. 18, a mask 2802 is formed having a back edge 2804 that extends slightly beyond the back edge of the free layer 1012 and capping layer 1014, leaving a structure as shown in FIG. 28. Then, with reference to FIG. 29, an ion milling is performed to remove portions of the fill layer 1702 that are not protected by the mask 2802, thereby exposing the pinned layer 1008 there-beneath. A layer of antiferromagnetic material 2902 such as PtMn or IrMn is then deposited, followed by a protective layer 2904 such as Ru.

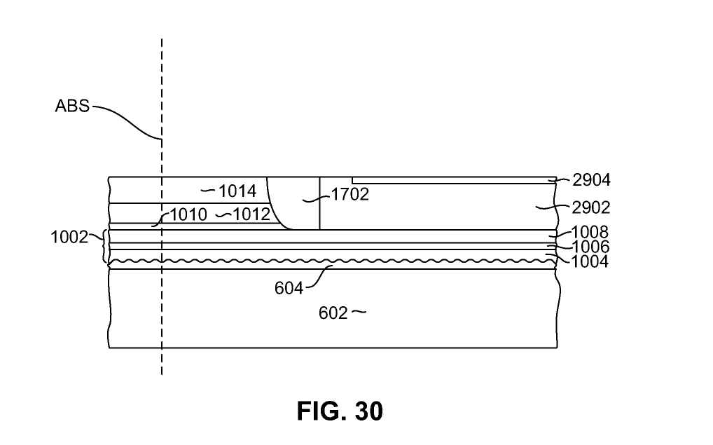

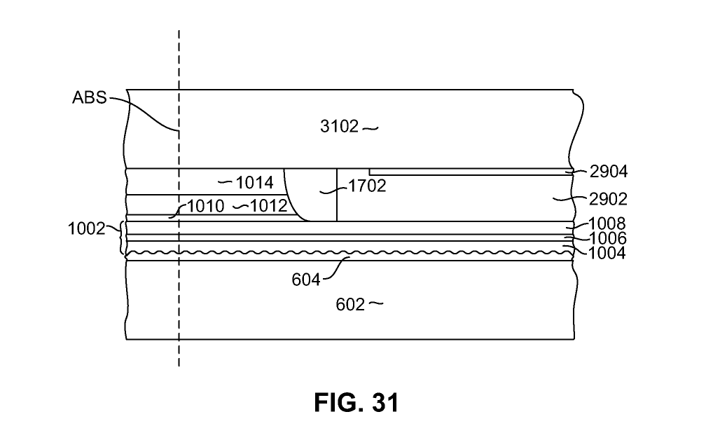

A chemical mechanical polishing process is then performed, leaving a structure as shown in FIG. 30. Then, an upper shield 3102 can be formed by electroplating a magnetic, electrically conductive material such as NiFe as shown in FIG. 31.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

1. A magnetic read sensor, comprising:
a seed layer having a surface formed with an anisotropic texture;
a pinned layer structure formed over the seed layer, at least a portion of the pinned layer structure comprising a material having a body centered cubic crystalline structure;
a non-magnetic layer formed over the pinned layer structure; and
a magnetic free layer structure formed over the non-magnetic layer, the free layer having a face centered cubic crystalline structure; wherein
the pinned layer structure has a smoothened surface over which the non-magnetic layer is formed, preventing the anisotropic texture from being imparted to the non-magnetic layer.

2. The magnetic read sensor as in claim 1, wherein:
the sensor has an air bearing surface;
the free layer structure extends to a first stripe height measured from the air bearing surface;
the pinned layer structure extends to a second stripe height measured from the air bearing surface; and
the second stripe height is greater than the first stripe height.

3. The magnetic read sensor as in claim 1 wherein at least a portion of the pinned layer structure comprises a Co—Fe alloy having a Co concentration of no greater than 60 atomic percent.

4. The magnetic read sensor as in claim 1 wherein at least a portion of the pinned layer structure comprises a Co—Fe alloy having a Co concentration of about 40 to 60 atomic percent.

5. The magnetic read sensor as in claim 1 wherein at least a portion of the pinned layer structure comprises a Co—Fe alloy having a Co concentration of about 50 atomic percent.

6. The magnetic read sensor as in claim 1 wherein at least a portion of the pinned layer structure comprises Co—Fe—B having a Co concentration of about 40 atomic percent.

7. The magnetic read sensor as in claim 1 wherein at least a portion of the pinned layer structure comprises Co₄₀Fe₄₀B₂₀.

8. The magnetic read sensor as in claim 1 wherein at least a portion of the free layer structure comprises a Co—Fe alloy having a Co concentration greater than 80 atomic percent.

9. The magnetic read sensor as in claim 1 wherein at least a portion of the free layer comprises a Co—Fe—B alloy having a Co concentration greater than 60 atomic percent.

10. The magnetic read sensor as in claim 1 wherein at least a portion of the free layer comprises a Ni—Fe alloy.

11. The magnetic read sensor as in claim 1 wherein the free layer is a bi-layer structure that includes a layer of Co₉₀Fe₁₀ contacting the non-magnetic layer and a layer of Co₇₂Fe8B₂₀ contacting the layer of Co₉₀Fe₁₀.

12. The magnetic read sensor as in claim 1 wherein the seed layer is a metal.

13. The magnetic read sensor as in claim 1 wherein the seed layer comprises Ru or Ta.

14. The magnetic read sensor as in claim 1 wherein the sensor has an air bearing surface, and the anisotropic texture comprises ripples aligned parallel with the air bearing surface and having a period of repetition that is perpendicular to the air bearing surface.

15. The sensor as in claim 1 wherein the anisotropic texture comprises ripples having a period of about 10 nm.

16. The sensor as in claim 1 wherein the anisotropic texture comprises ripples having an amplitude of about 1 nm.

17. The sensor as in claim 1 wherein the seed layer has a thickness of about 2 nm.

18. A magnetic data recording system, comprising:
a housing;
a magnetic media held within the housing;
a slider arranged within the housing for movement adjacent to a surface of the magnetic media; and
a magnetic read sensor formed on the slider, the magnetic read sensor further comprising:
a seed layer having a surface formed with an anisotropic texture;
a pinned layer structure formed over the seed layer, at least a portion of the pinned layer comprising a material having a body centered cubic crystalline structure;
a non-magnetic layer formed over the pinned layer structure; and
a magnetic free layer structure formed over the non-magnetic layer, the free layer having a face centered cubic crystalline structure; wherein
the pinned layer structure has a smoothened surface over which the non-magnetic layer is formed, preventing the anisotropic texture from being imparted to the non-magnetic layer.

19. A method for manufacturing a magnetic read sensor, comprising:
depositing a metal seed layer;
performing an angled ion etching on the metal seed layer to form an anisotropic texture on the metal seed layer; and
depositing a series of sensor layers over the seed layer, the sensor layers including a magnetic pinned layer structure at least a portion of which has a body centered cubic crystalline structure, a non-magnetic layer deposited over the pinned layer structure and a magnetic free layer structure deposited over the non-magnetic layer at least a portion of which has a face centered cubic structure.

20. The method as in claim 20 further comprising, before depositing the non-magnetic layer performing a low power ion bombardment.
